(19) United States
(12) Patent Application Publication
(10) Pub. No.: US 2023/0386232 A1
(43) Pub. Date: Nov. 30, 2023

(54) METHOD FOR CLASSIFYING AN INPUT IMAGE CONTAINING A PARTICLE IN A SAMPLE

(71) Applicants: BIOMERIEUX, Marcy L'etoile (FR); BIOASTER, Lyon (FR)

(72) Inventors: Pierre MAHÉ, Lans En Vercors (FR); Meriem EL AZAMI, L’arbresle (FR); Elodie DEGOUT-CHARMETTE, Toussieux (FR); Zohreh SEDAGHAT, La Mulatiere (FR); Quentin JOSSO, Lyon (FR); Fabian ROL, La Verpilliere (FR)

(73) Assignees: BIOMERIEUX, Marcy L'etoile (FR); BIOASTER, Lyon (FR)

(21) Appl. No.: 18/031,729

(22) PCT Filed: Oct. 19, 2021
(86) PCT No.: PCT/FR2021/051818

§ 371 Date: Apr. 13, 2023

(30) Foreign Application Priority Data
Oct. 20, 2020 (FR) FR2010740

(51) Int. Cl. G06V 20/69; G06V 10/774

(52) U.S. Cl. CPC G06V 20/698; G06V 20/695; G06V 10/774

(57) ABSTRACT

A method for classifying at least one input image containing a target particle in a sample, involves implementing, via data-processing of a client, steps of: (b) extracting a vector of characteristics of the target particle, the characteristics being numerical coefficients each associated with one elementary image of a set of elementary images each representing a reference particle, such that a linear combination of the elementary images weighted by the coefficients approximates the representation of the target particle in the input image; (c) classifying the input image depending on the extracted vector of characteristics.

### CROSS-REFERENCE TO RELATED APPLICATIONS

This application is a national phase entry of PCT Patent Application Ser. No. PCT/FR2021/051818 filed on Oct. 19, 2021, which claims priority to the French Patent Application Serial. No. FR2010740 filed Oct. 20, 2020, both of which are incorporated by reference herein.

### TECHNICAL FIELD

The present invention relates to the field of optical acquisition of biological particles. The biological particles may be microorganisms such as bacteria, fungi or yeasts for example. It may also be a question of cells, multicellular organisms, or any other type of particle such as pollutants or dust.

The invention is particularly advantageously applicable to analysis of the state of a biological particle, for example with a view to determining the metabolic state of a bacterium following application of an antibiotic. The invention makes it possible, for example, to carry out an antibiogram on a bacterium.

### BACKGROUND

An antibiogram is a laboratory technique aimed at testing the phenotype of a bacterial strain against one or more antibiotics. An antibiogram is conventionally carried out by culturing a sample containing bacteria and an antibiotic.

European patent application No. 2 603 601 describes a method for carrying out an antibiogram involving visualizing the state of the bacteria after an incubation period in the presence of an antibiotic. To visualize the bacteria, the bacteria are labeled with fluorescent markers allowing their structures to be revealed. Measurement of the fluorescence of the markers then makes it possible to determine whether the antibiotic has acted effectively on the bacteria.

The conventional process for determining antibiotics that are effective against a given bacterial strain consists in taking a sample containing said strain (e.g. from a patient, an animal, a food batch, etc.) then sending the sample to an analysis center. When the analysis center receives the sample, it first cultures the bacterial strain to obtain at least one colony thereof, this taking between 24 hours and 72 hours. It then prepares, from this colony, several samples comprising different antibiotics and/or different concentrations of antibiotics, then again incubates the samples. After a new period of culturing, which also takes between 24 and 72 hours, each sample is analyzed manually to determine whether the antibiotic has acted effectively. The results are then sent back to the practitioner so that he may apply the most effective antibiotic and/or antibiotic concentration.

However, the labeling process is particularly long and complex to perform and these chemical markers have a cytotoxic effect on bacteria. Hence, this visualizing method does not allow bacteria to be observed a number of times during their culture, and as a result the bacteria must be cultured for long enough, about 24 to 72 hours, to guarantee the reliability of the measurement. Other methods of visualizing biological particles use a microscope, allowing non-destructive measurement of a sample.

Digital holographic microscopy or DHM is an imaging technique that allows the depth-of-field constraints of conventional optical microscopy to be overcome. Schematically, it consists in recording a hologram formed by interference between light waves diffracted by the observed object and a spatially coherent reference wave. This technique is described in the review article by Myung K. Kim entitled “Principles and techniques of digital holography microscopy” published in SPIE Reviews Vol. 1, No. 1, January 2010.

Recently, it has been proposed to use digital holographic microscopy to identify microorganisms in an automated manner. Thus, international application WO2017/207184 describes a method for acquiring a particle, this method associating simple defocused acquisition with digital focus reconstruction so as to make it possible to observe a biological particle while limiting acquisition time.

Typically, this solution makes it possible to detect structural modifications to a bacterium in the presence of an antibiotic after an incubation of only about ten minutes, and the sensitivity thereof after two hours (detection of the presence or absence of division or a pattern indicating division), unlike the conventional process described above, which may take several days. Specifically, since the measurements are non-destructive, it is possible to carry out analyses very early on in the culturing process without running the risk of destroying the sample and therefore of prolonging the analysis time.

It is even possible to track a particle over a plurality of successive images so as to form a film representing the progress of a particle over time (since the particles are not spoiled after the first analysis) in order to visualize its behavior, for example its speed of movement or its process of cell division.

It will therefore be understood that this visualizing method gives excellent results. The difficulty lies in the interpretation of these images or this film per se, for example if it is desired to reach a conclusion as to the susceptibility of a bacterium to the antibiotic present in the sample.

Various techniques have been proposed, ranging from simply counting bacteria over time to so-called morphological analysis, which aims to detect particular “configurations” via image analysis. For example, when a bacterium is preparing to divide, two poles appear in the distribution, well before the division itself which results in the distribution dividing into two distinct segments.

It has been proposed in the article Choi et al. 2014 to combine these two techniques to assess antibiotic effectiveness. However, as underlined by the authors, their approach requires very fine calibration of a certain number of thresholds that strongly depend on the nature of the morphological changes caused by the antibiotics.

More recently, the article Yu et al. 2018 has described an approach based on deep learning. The authors propose to extract morphological features and features related to the movement of bacteria using a convolutional neural network (CNN). However, this solution turns out to be very intensive in terms of computing resources, and requires a vast database of training images to train the CNN.

The objective technical problem of the present invention is, therefore, that of making it possible to provide a solution for classifying images of a biological particle that is both more effective and less resource intensive.

### SUMMARY

According to a first aspect, the present invention relates to a method for classifying at least one input image representing a target particle in a sample, the method being characterized in that it comprises implementation, by data-processing means of a client, of steps of:
(b) extraction of a feature vector of features of said target particle, said features being numerical coefficients each associated with one elementary image of a set of elementary images each representing a reference particle such that a linear combination of said elementary images weighted by said coefficients approximates the representation of said target particle in the input image;
(c) classification of said input image depending on said extracted feature vector.

According to advantageous but non-limiting features:

The particles are represented in a uniform manner in the input image and in each elementary image, and in particular centered on and aligned in a predetermined direction.

The method comprises a step (a) of extracting said input image from an overall image of the sample, so as to represent said target particle in said uniform manner.

Step (a) comprises segmentation of said overall image so as to detect said target particle in the sample, then cropping of the input image to said detected target particle.

Step (a) comprises obtaining said overall image from an intensity image of the sample, said image being acquired by an observing device.

The method comprises a step (b0) of unsupervised learning, using a database of training images of particles in said sample, of the elementary images.

The learnt reference images are those which allow the best approximation of the representations of the particles in the training images by a linear combination of said elementary images.

Step (c) is implemented by means of a classifier, the method comprising a step (a0) of training, by data-processing means of a server, parameters of said classifier using a training database of already classified feature vectors/matrices of particles in a sample.

Said classifier is chosen from a support vector machine, a k-nearest neighbor algorithm, or a convolutional neural network.

Step (c) comprises a reduction of the number of variables of the feature vector, by means of the t-SNE algorithm.

The method is a method for classifying a sequence of input images representing said target particle in a sample over time, wherein step (b) comprises obtaining a feature matrix of said target particle by concatenating the extracted feature vectors of each input image of said sequence.

According to a second aspect, a system is provided for classifying at least one input image representing a target particle in a sample comprising at least one client comprising data-processing means, characterized in that said data-processing means are configured to implement:
extraction of a feature vector of features of said target particle, said features being numerical coefficients each associated with one elementary image of a set of elementary images each representing a reference particle such that a linear combination of said elementary images weighted by said coefficients approximates the representation of said target particle in the input image;
classification of said input image depending on said extracted feature vector.

According to advantageous but non-limiting features, the system further comprises a device for observing said target particle in the sample.

According to third and fourth aspects the following are provided: a computer program product comprising code instructions for executing a method according to the first aspect for classifying at least one input image representing a target particle in a sample; and a storage medium readable by a piece of computer equipment, on which a computer program product comprises code instructions for executing a method according to the first aspect for classifying at least one input image representing a target particle in a sample.

### BRIEF DESCRIPTION OF THE DRAWINGS

Other features and advantages of the present invention will become apparent on reading the following description of a preferred embodiment. This description will be given with reference to the appended drawings, in which:

FIG. 1 is a schematic of an architecture for implementing the method according to the invention;

FIG. 2 shows one example of a device for observing particles in a sample, which device is used in one preferred embodiment of the method according to the invention;

FIG. 3a illustrates obtainment of the input image in one embodiment of the method according to the invention;

FIG. 3b illustrates obtainment of the input image in a preferred embodiment of the method according to the invention;

FIG. 4 shows the steps of a preferred embodiment of the method according to the invention;

FIG. 5a shows one example of a dictionary of elementary images used in a preferred embodiment of the method according to the invention;

FIG. 5b shows one example of extraction of a feature vector and matrix in a preferred embodiment of the method according to the invention;

FIG. 6 represents an example of t-SNE embedding used in a preferred embodiment of the method according to the invention.

### DETAILED DESCRIPTION

### Architecture

The invention relates to a method for classifying at least one input image representative of a particle 11a-11f present in a sample 12, referred to as the target particle. It should be noted that the method may be implemented in parallel for all or some of the particles 11a-11f present in a sample 12, each being considered a target particle in turn.

As will be seen, this method may comprise one or more machine-learning components, and in particular one or more classifiers, including a convolutional neural network, CNN.

The input or training data are of the image type, and represent the target particle 11a-11f in a sample 12 (in other words, these are images of the sample in which the target particle is visible). As will be seen, a sequence of images of the same target particle 11a-11f (or where appropriate a plurality of sequences of images of particles 11a-11f of the sample 12 if a plurality of particles are considered) may be provided as input.

The sample 12 consists of a liquid such as water, a buffer solution, a culture medium or a reactive medium (including or not including an antibiotic), in which the particles 11a-11f to be observed are located.

As a variant, the sample 12 may take the form of a, preferably translucent, solid medium such as an agar-agar, in which the particles 11a-11f are located. The sample 12 may also be a gaseous medium. The particles 11a-11f may be located inside the medium or else on the surface of the sample 12.

The particles 11a-11f may be microorganisms such as bacteria, fungi or yeasts. It may also be a question of cells, multicellular organisms, or any other type of particle such as pollutants or dust. In the rest of the description, the preferred example in which the particle is a bacterium (and, as will be seen, the sample 12 incorporates an antibiotic) will be considered. The size of the observed particles 11a-11f varies between 500 nm and a plurality of hundred μm, or even a few millimeters.

The “classification” of an input image (or of a sequence of input images) consists in determining at least one class among a set of possible classes descriptive of the image. For example, in the case of bacteria type particles, a binary classification may be employed, i.e. two possible classes may be employed indicating “division” or “no division”, testifying to the presence or absence of resistance to an antibiotic, respectively. The present invention is not limited to any one particular kind of classification, although the example of a binary classification of the effect of an antibiotic on said target particle 11a-11f will mainly be described.

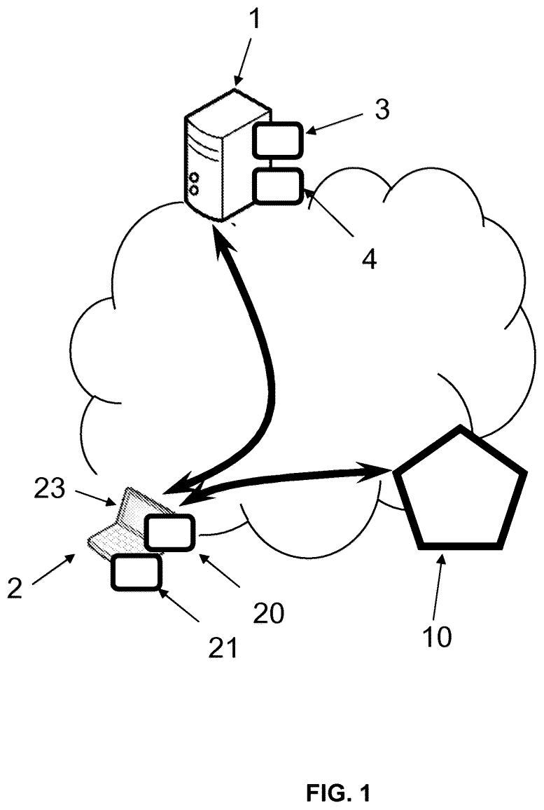

The present methods are implemented within an architecture such as shown in FIG. 1, by virtue of a server 1 and a client 2. The server 1 is the piece of equipment that is trained (implementing the training method) and the client 2 is a piece of user equipment (implementing the classifying method), for example a terminal of a doctor or of a hospital.

It is quite possible for the two pieces of equipment 1, 2 to be combined, but preferably the server 1 is a remote piece of equipment, and the client 2 is a mass-market piece of equipment, in particular a desktop computer, a laptop computer, etc. The client equipment 2 is advantageously connected to an observing device 10, so as to be able to directly acquire said input image (or, as will be seen below, “raw” acquisition data such as an overall image of the sample 12, or even electromagnetic matrices), typically with a view to processing it straight away. Alternatively the input image will be loaded onto the client equipment 2.

In all cases, each piece of equipment 1, 2 is typically a remote piece of computer equipment connected to a local network or to a wide area network such as the Internet with a view to exchanging data. Each comprises data-processing means 3, 20 of the processor type, and data-storing means 4, 21 such as a computer memory, for example a flash memory or a hard disk. The client 2 typically comprises a user interface 22 such as a screen allowing interaction.

The server 1 advantageously stores a training database, i.e. a set of images of particles 11a-11f in various conditions (see below) and/or a set of already classified feature vectors/matrices (for example associated with labels “divided” or “not divided” indicating sensitivity or resistance to the antibiotic). It should be noted that the training data will possibly be associated with labels defining test conditions, for example indicating, in regard to cultures of bacteria, “strains”, “antibiotic conditions”, “time”, etc.

### Acquisition

As explained above, the present method is able to take directly as input any image of the target particle 11a-11f, obtained in any way. However, the present method preferably begins with a step (a) of obtaining the input image from data delivered by an observing device 10.

In a known manner, a person skilled in the art will be able to use DHM techniques (DHM standing for digital holographic microscopy), in particular such as described in international application WO2017/207184. In particular, an intensity image of the sample 12 that is not focused on the target particle (the image is said to be “out of focus”) but that is able to be processed by data-processing means (which are either integrated into the device 10 or those 20 of the client 2 for example, see below) may be acquired, such an image being called a hologram. It will be understood that the hologram “represents” in a certain way all the particles 11a-11f in the sample.

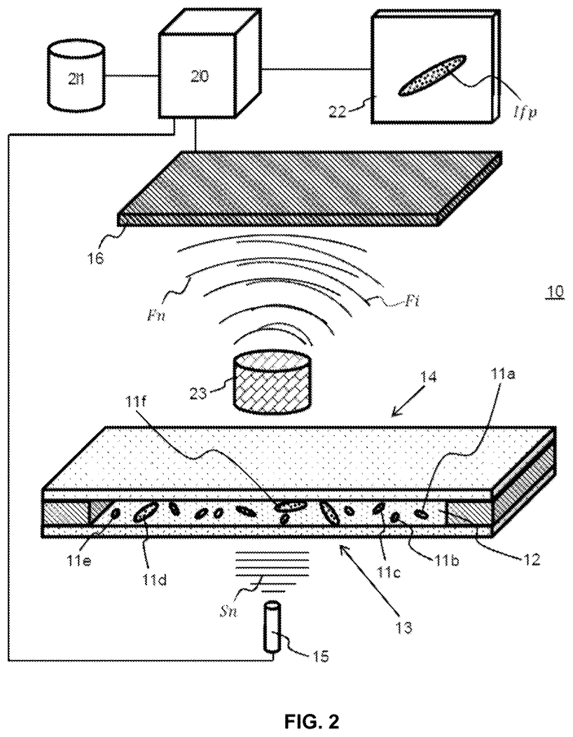

FIG. 2 illustrates an example of a device 10 for observing a particle 11a-11f present in a sample 12. The sample 12 is arranged between a light source 15 that is spatially and temporally coherent (e.g. a laser) or pseudo-coherent (e.g. a light-emitting diode, a laser diode), and a digital sensor 16 sensitive in the spectral range of the light source. Preferably, the light source 15 has a narrow spectral width, for example narrower than 200 nm, narrower than 100 nm or even narrower than 25 nm. In what follows, reference is made to the central emission wavelength of the light source, which for example lies in the visible domain. The light source 15 emits a coherent signal Sn toward a first face 13 of the sample, the signal for example being conveyed by a waveguide such as an optical fiber.

The sample 12 (as explained typically a culture medium) is contained in an analysis chamber that is bounded vertically by a lower slide and an upper slide, for example conventional microscope slides. The analysis chamber is bounded laterally by an adhesive or by any other seal-tight material. The lower and upper slides are transparent to the wavelength of the light source 15, the sample and the chamber allowing for example more than 50% of the wavelength of the light source to pass under normal incidence on the lower slide.

Preferably, the particles 11a-11f are located in the sample 12 next to the upper slide. The bottom face of the upper slide comprises, to this end, ligands allowing attachment of the particles, for example polycations (e.g. poly-L-lysine) in the context of micro-organisms. This makes it possible to contain the particles in a thickness equal to, or close to, the depth of field of the optical system, namely in a thickness smaller than 1 mm (e.g. tube lens), and preferably smaller than 100 μm (e.g. microscope objective). The particles 11a-11f may nevertheless move in sample 12.

Preferably, the device comprises an optical system 23 consisting, for example, of a microscope objective and of a tube lens, placed in the air and at a fixed distance from the sample. The optical system 23 is optionally equipped with a filter that may be located in front of the objective or between the objective and the tube lens. The optical system 23 is characterized by its optical axis; its object plane (also called the plane of focus), which is at distance from the objective; and its image plane, which is conjugated with the object plane by the optical system. In other words, to an object located in the object plane, corresponds a sharp image of this object in the image plane, also called the focal plane. The optical properties of the system 23 are fixed (e.g. fixed focal length optics). The object and image planes are orthogonal to the optical axis.

The image sensor 16 is located, facing a second face 14 of the sample, in the focal plane or in proximity to the latter. The sensor, for example a CCD or CMOS sensor, comprises a periodic two-dimensional array of elementary sensitive sites, and associated electronics that adjust exposure time and zero the sites, in a manner known per se. The signal output from an elementary site is dependent on the amount of radiation in the spectral range incident on said site during the exposure time. This signal is then converted, for example by the associated electronics, into an image point, or “pixel”, of a digital image. The sensor thus produces a digital image taking the form of a matrix of C columns and of L rows. Each pixel of this matrix, of coordinates (c, l) in the matrix, corresponds in a manner known per se to a position of Cartesian coordinates (x(c, l), y(c, l)) in the focal plane of the optical system 23, for example the position of the center of an elementary sensitive site of rectangular shape.

The pitch and fill factor of the periodic array are chosen to meet the Nyquist criterion with respect to the size of the observed particles, so as to define at least two pixels per particle. Thus, the image sensor 16 acquires a transmission image of the sample in the spectral range of the light source.

The image acquired by the image sensor 16 includes holographic information insofar as it results from interference between a wave diffracted by the particles 11a-11f and a reference wave having passed through the sample without interacting with it. It should be obvious, as described above, that, in the context of a CMOS or CCD sensor, the acquired digital image is an intensity image, the phase information therefore here being encoded in this intensity image.

Alternatively, it is possible to divide the coherent signal Sn generated by the light source 15 into two components, for example by means of a semi-transparent plate. The first component then serves as a reference wave and the second component is diffracted by the sample 12, the image in the image plane of the optical system 23 resulting from interference between the diffracted wave and the reference wave.

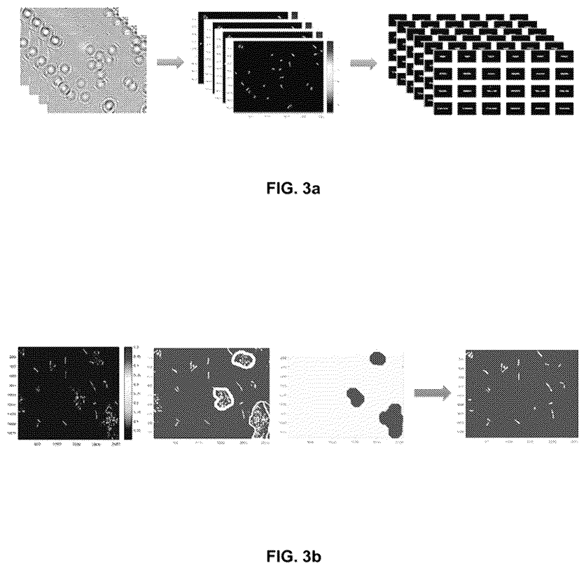

With reference to FIG. 3a, it is possible, in step (a), to reconstruct from the hologram at least one overall image of the sample 12, then to extract said input image from the overall image of the sample.

Specifically, it will be understood that the target particle 11a-11f must be represented in a uniform manner in the input image, and in particular be centered on and aligned in a predetermined direction (for example the horizontal direction). The input images must further have a standardized size (it is also desirable for only the target particle 11a-11f to be seen in the input image). The input image is thus called a “thumbnail”, and its size may for example be defined to be 250×250 pixels. In the case of a sequence of input images, one image is for example taken per minute during a time interval of 120 minutes, the sequence thus forming a 3D “stack” of 250×250×120 size.

The overall image is reconstructed as explained by the data-processing means of the device 10 or those 20 of the client 2.

Typically, a series of complex matrices, called “electromagnetic matrices”, are constructed (for each given acquisition time), these matrices modeling, based on the intensity image of the sample 12 (the hologram), the wavefront of the light wave propagated along the optical axis for a plurality of deviations with respect to the plane of focus of the optical system 23, and in particular deviations positioned in the sample.

These matrices may be projected into real space (for example via the Hermitian norm), so as to form a stack of overall images at various focal distances.

Therefrom it is possible to determine an average focal distance (and select the corresponding overall image, or to recompute it from the hologram), or even to determine an optimal focal distance for the target particle (and again select the corresponding overall image, or to recompute it from the hologram).

In any case, with reference to FIG. 3b, step (a) advantageously comprises segmentation of said one or more overall images so as to detect said target particle in the sample, then cropping. In particular, said input image may be extracted from the overall image of the sample, so as to represent said target particle in said uniform manner.

In general, the segmentation allows all the particles of interest to be detected, while removing artifacts such as filaments or micro-colonies so as to improve the one or more overall images, then one of the detected particles is selected as target particle, and the corresponding thumbnail is extracted. As explained, this may be done for all the detected particles.

The segmentation may be implemented in any known way. In the example of FIG. 3b, first fine segmentation is carried out to eliminate artifacts, then coarser segmentation is carried out to detect the particles 11a-11f. Any segmentation technique known to those skilled in the art may be used.

If it is desired to obtain a sequence of input images for a target particle 11a-11f, tracking techniques may be used to track any movements of the particle from one overall image to the next.

It should be noted that all the input images obtained over time for a given sample (for a plurality of or even all the particles of the sample 12) may be pooled to form a corpus descriptive of the sample 12 (in other words a corpus descriptive of the experiment), as seen on the right of FIG. 3a, this corpus in particular being copied to the storage means 21 of the client 2. This is the “field” level as opposed to the “particle” level. For example, if the particles 11a-11f are bacteria and the sample 12 contains (or does not contain) an antibiotic, this descriptive corpus contains all the information on the growth, the morphology, the internal structure and the optical properties of these bacteria over the whole field of acquisition. As will be seen, this descriptive corpus may be transmitted to the server 1 for integration into said training database.

### Feature Extraction

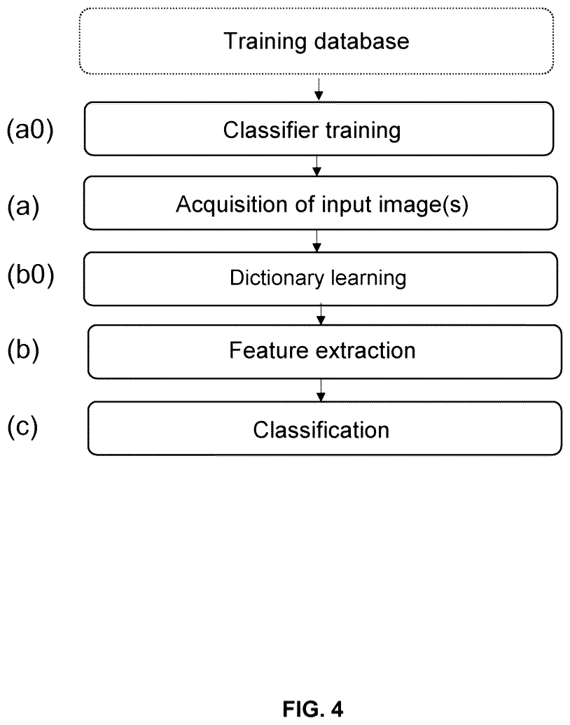

With reference to FIG. 4, the present method is particularly noteworthy in that a step (b) of extraction of a feature vector from the input image is carried out separately from a step (c) of classification of the input image depending on said feature vector, instead of attempting to classify the input image directly. As will be seen, each step may involve an independent machine-learning mechanism and hence said training database of the server 1 may comprise particle images and feature vectors that are not necessarily already classified.

The main step (b) is thus a step of extraction by the data-processing means 20 of the client 2 of a feature vector of said target particle, that is to say “coding” of the target particle.

In the remainder of the present description, a distinction will be made between the number of “dimensions” of the feature vectors/matrices in the geometric sense, i.e. the number of independent directions in which these maps extend (for example a vector is an object of dimension 1, and a matrix is an object of dimension 2, advantageously of dimension 3), and the number of “variables” of these feature vectors/matrices, i.e. size in each dimension, i.e. the number of independent degrees of freedom (which in practice corresponds to the notion of dimension in a vector space—more precisely, a set of feature vectors/matrices having a given number of variables forms a vector space of dimension equal to this number of variables).

Thus, an example in which a feature matrix extracted at the end of step (b) is a two-dimensional object (i.e. an object of dimension 2) of 60×25 size and thus having 1500 variables, will be described below.

In this case, the specificity of the present coding lies in the fact that said features are numerical coefficients each associated with one elementary image of a set of elementary images each representing a reference particle such that a linear combination of said elementary images weighted by said coefficients approximates the representation of said particle in the input image.

This is called “sparse coding”. Said elementary images are called “atoms”, and the set of atoms is called a “dictionary”. The idea behind sparse coding is to express any input image as a linear combination of said atoms, by analogy with dictionary words. More precisely, for a dictionary D of size p, and denoting α a feature vector also of size p, the best approximation Dα of the input image x is sought. In other words, denoting α* the optimal vector (the sparse code of the input image x), step (b) consists in solving a problem of minimization of a functional with λ a regularization parameter (which makes it possible to make a compromise between the quality of the approximation and the sparsity of the vector, i.e. to involve the fewest atoms possible). For example, the constrained minimization problem may be stated as follows:

$${α}^{*} ∈ {arg min}_{α ∈ {ℝ}^{p}} [ {‖ α ‖}_{1} t \cdot q \cdot x = D α ]$$

It may also be expressed as a variational-formulation problem:

$${α}^{*} = {arg min}_{α ∈ {ℝ}^{p}} [ \frac{1}{2} {‖ x - D α ‖}_{2}^{2} + λ {‖ α ‖}_{1} ]$$

Said coefficients advantageously have a value in the interval [0, 1] (this is simpler than in R), and it will be understood that in general most of the coefficients have a value of 0, because of the “sparse” character of the coding. Atoms associated with non-zero coefficients are called activated atoms.

Naturally, the elementary images are thumbnails comparable to the input images, i.e. the reference particles are represented therein in the same uniform manner as in the input image, and in particular centered on and aligned in said predetermined direction, and the elementary images advantageously have the same size as the input images (for example 250×250).

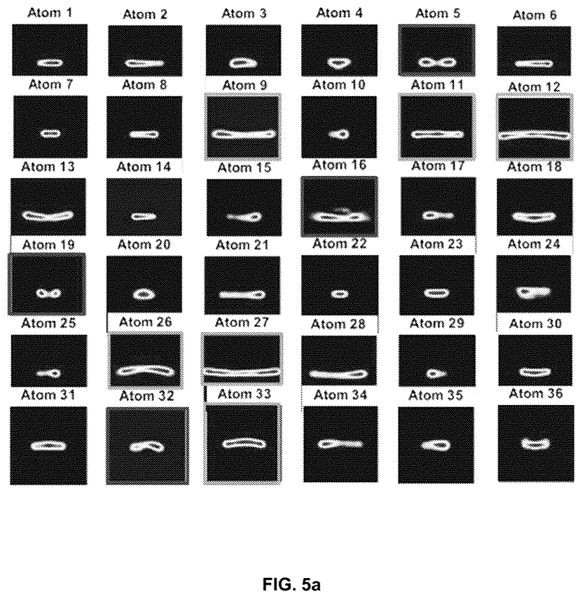

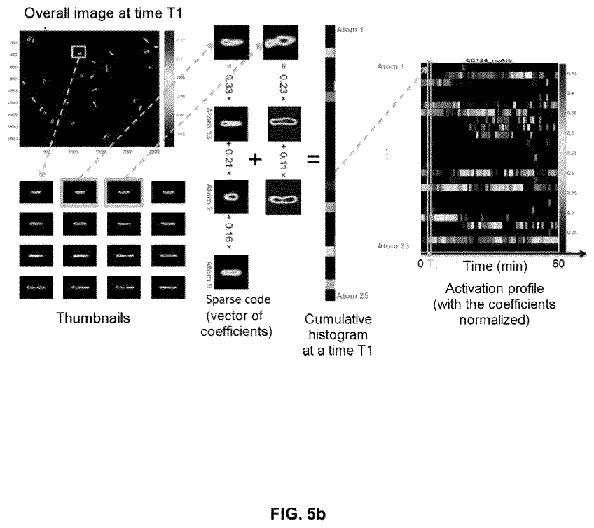

FIG. 5a thus illustrates an example of a dictionary of 36 elementary images (case of the bacterium E. coli with the antibiotic cefpodoxime).

In the case where a sequence of input images is supplied, step (b) thus advantageously comprises extraction of one feature vector per input image, which feature maps may be combined into a feature matrix called the “profile” of the target particle. More precisely, the vectors all have the same size (the number of atoms) and form a sequence of vectors, so it is enough to juxtapose them in the order of the input images to obtain a sparse two-dimensional code (coding spatio-temporal information, hence the two dimensions).

Alternatively or in addition, the feature vectors/matrices corresponding to a plurality of input images associated with a plurality of particles 11a-11f of the sample 12 may be summed.

The present technique thus allows a feature vector of high semantic level to be obtained without either a large amount of computing power or an annotated database being required.

FIG. 5b shows another example of extraction of a feature vector, this time with a dictionary of 25 atoms. The whole of the overall image obtained at a given time T1, and the various extracted input images (corresponding to detected particles), have been shown. Thus, the image representing the 2^{nd} target particle may be approximated as 0.33 times atom 13 plus 0.21 times atom 2 plus 0.16 times atom 9 (i.e. a vector (0; 0.21; 0; 0; 0; 0; 0; 0; 0.16 0; 0; 0; 0.33; 0; 0; 0; 0; 0; 0; 0; 0; 0; 0; 0; 0).

The summed vector, which is called the “cumulative histogram” is shown in the middle. Advantageously, the coefficients are normalized so that their sum is equal to 1. The summed matrix (summation over 60 minutes), which is called the “activation profile”, has been shown on the right—it may be seen that it thus has a size of 60×25.

It will be understood that this activation profile is a high-level feature map representative of the sample 12 (over time).

### Learning of the Atoms

The reference images (atoms) may be predefined. However, preferably, the method comprises a step (b0) of learning from a training database, in which step reference images (i.e. the images of the dictionary) are learnt, in particular by the data-processing means 3 of the server 1, so that at no point does the method require any human intervention.

This learning method, which is called “dictionary learning” since it involves learning a dictionary, is unsupervised insofar as it does not require the images of the training database to be annotated, and is therefore extremely simple to implement. Specifically, it will be understood that annotating thousands of images by hand would be very time consuming and very expensive.

The idea is simply to provide, in the training database, thumbnails representing particles 11a-11f in various conditions and, based thereon, to find atoms allowing any thumbnail to be represented as easily as possible.

Preferably, there may be different dictionaries per type of particle 11a-11f and/or per type of sample 12. In particular, in the embodiment in which the particles 11a-11f are bacteria, there is one dictionary per type of bacterium and per antibiotic. The various conditions are in particular obtained using various concentrations of antibiotics. It may however be envisioned to employ the same training database for a plurality of antibiotics, etc.

It will be noted that step (b0) may be carried out very far upstream or wait for the result of step (a) (the database representative of the experiment in progress) to refine the result.

In any case, learning may be performed in any way known to those skilled in the art, and especially once again correspond to an optimization problem. If the images of the training database are denoted xᵢ, i≤N, the problem is thus for example:

$${min}_{D ∈ C , α ∈ {ℝ}^{p \times N}} {\sum }_{i = 1}^{N} ( \frac{1}{2} {‖ {x}_{i} - D {α}_{i} ‖}_{2}^{2} + λ {‖ {α}_{i} ‖}_{1} )$$

Specifically, the aim is to find the dictionary D allowing the best approximation Dαᵢ of each training image xᵢ.

The SPAMS toolbox will for example possibly be used to perform the learning (SPAMS standing for SPArse Modeling Software).

The 36 atoms of FIG. 5a were thus learnt using a database of several tens of thousands of input images acquired over 61 minutes from a culture of 6 strains of E. coli (2 non-resistant strains and 4 resistant strains), with up to 4 different concentrations of cefpodoxime (plus the case of absence of antibiotic). The 36 atoms were obtained with a regularization parameter A set to 0.2. Atoms 5, 16, 19 and 32 correspond to a bacterium in the process of (normal) division, whereas atoms 9, 11, 12, 26, 27 and 33 show morphological changes induced by the cefpodoxime.

Other dictionaries have been successively learnt for other bacteria such as S. aureus and/or other antibiotics such as cefoxitin, gentamicin, etc.

### Classification

In a step (c), said input image is classified depending on said extracted feature vector.

It will be understood that any technique allowing a descriptive analysis of the one or more feature vectors/matrices, and in particular classifiers trained on said training database (a number of examples will be given below), will potentially be used. In this regard, just like step (b0), the method may comprise a step (a0) of training, by the data-processing means 3 of the server 1, using a training database, the classifier. Specifically, this step is typically carried out very far upstream, in particular by the remote server 1. As explained, the training database may contain a certain number of feature vectors/matrices of training images i.e. their sparse codes, this taking up little space.

The sparse code obtained in step (b) (in particular in the case of a matrix) may have a very high number of variables and hence visualization and interpretation of the results of analysis is complex, and it is preferable to use reduction techniques.

It is therefore possible to use the t-SNE algorithm (t-SNE standing for t-distributed stochastic neighbor embedding) which is a non-linear method of achieving a reduction of the number of variables for data visualization, allowing a set of points of a high-dimensional space to be represented (the value space of the sparse codes/activation profiles) in a space of two or three dimensions—the data may then be visualized with a scatter plot. The t-SNE algorithm attempts to find a configuration (called t-SNE embedding) that is, according to an information-theory criterion, optimal in respect of the proximities of points: two points which are close (respectively far apart) in the original space must be close (respectively far apart) in the low-dimension space.

The t-SNE algorithm may be implemented both at the particle level (a target particle 11a-11f with respect to the individual particles for which a vector is available in the training database) and at the field level (for the whole sample 12—case of a plurality of input images representing a plurality of particles 11a-11f), in particular in the case of single vectors rather than of feature matrices.

It should be noted that t-SNE embedding may be achieved efficiently by virtue in particular of implementation for example in python, and hence it can be carried out in real time. It is also possible, to accelerate the computations and reduce memory footprint, to go through a first step of linear reduction of dimensionality (for example PCA—Principal Component Analysis) before computing the t-SNE embeddings of the training database and of input image in question. In this case, the PCA embeddings of the training database may be stored in memory, all that then remains being to complete embedding with the sparse code of the input image in question.

For the actual classifier, it is possible to use the k-NN method (k-NN standing for k-nearest neighbors), in particular on the result of the t-SNE algorithm (the obtained embedding).

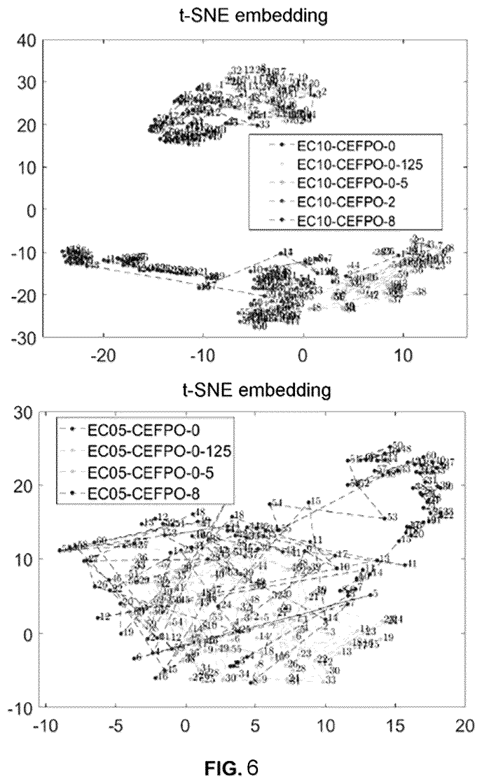

The idea is to look at the neighboring points of the point corresponding to the feature vector of the one or more input images in question, and to look at their classification. For example, if the neighboring points are classified “no division”, it may be assumed that the input image in question must be classified “no division”. It should be noted that the neighbors considered may possibly be limited, for example depending on the strain, the antibiotic, etc. FIG. 6 shows two examples of t-SNE embeddings obtained for a strain of E. coli for various concentrations of cefpodoxime. In the top example, two blocks may clearly be seen, visually demonstrating the existence of a minimum inhibitory concentration (MIC) above which morphology and therefore cell division is affected. A vector falling close to the upper part might be classified “division” and a vector falling close to the lower part might be classified “no division”. In the bottom example it may be seen that only the highest concentration stands out (and therefore seems to have an antibiotic effect).

According to a second embodiment, a support vector machine (SVM) is used as classifier, again to obtain a binary classification (for example again “division” or “no division”). This simple method is particularly effective on single input images (SVM applied to the feature vectors). The hyper-parameter C of the SVM may be optimized using a grid search and a so-called k-fold cross validation (in particular with k=5, in which the original database is divided into k samples, then one of the k samples is selected as validation set and the k−1 other samples form the training set).

According to a third embodiment, in the case of sequences of input images (3D stack) and therefore of feature matrices, a convolutional neural network (CNN) is used as classifier.

This CNN may have a relatively simple architecture, for example one consisting of a succession of blocks of one convolution layer, one activation layer (ReLU function for example) and one pooling layer (a max-pooling layer for example). Two such blocks are enough to achieve an effective binary classification. It is moreover possible to downsample the inputs (in particular in the “time” dimension) to further decrease its memory footprint.

The CNN may be trained in a conventional way. The training cost function may be composed of a conventional cost function—cross-entropy for example—and of a total variation regularization.

In all the embodiments, the trained classifier may be stored, where appropriate, on data-storing means 21 of the client 2 for classification purposes. It will be noted that the same classifier may be installed on many clients 2, only one training phase being required.

### Computer Program Product

According to second and third aspects, the invention relates to a computer program product comprising code instructions for executing (in particular on the data-processing means 3, 20 of the server 1 and/or of the client 2) a method for classifying at least one input image representing a target particle 11a-11f in a sample 12, as well as storage means readable by a piece of computer equipment (a memory 4, 21 of the server 1 and/or of the client 2), on which this computer program product is stored.

1. A method for classifying at least one input image representing a target particle in a sample, the method being characterized in that it comprises implementation, by data-processing means of a client, of steps of:
(b) extraction of a feature vector of features of said target particle, said features being numerical coefficients each associated with one elementary image of a set of elementary images each representing a reference particle such that a linear combination of said elementary images weighted by said coefficients approximates the representation of said target particle in the input image;
(c) classification of said input image depending on said extracted feature vector.

2. The method as claimed in claim 1, wherein the particles are represented in a uniform manner in the input image and in each elementary image, and in particular centered on and aligned in a predetermined direction.

3. The method as claimed in claim 2, comprising a step (a) of extracting said input image from an overall image of the sample, so as to represent said target particle in said uniform manner.

4. The method as claimed in claim 3, wherein step (a) comprises segmentation of said overall image so as to detect said target particle in the sample, then cropping of the input image to said detected target particle.

5. The method as claimed in claim 3, wherein step (a) comprises obtaining said overall image from an intensity image of the sample, said image being acquired by an observing device.

6. The method as claimed in claim 1, comprising a step (b0) of unsupervised learning, using a database of training images of particles in said sample, of the elementary images.

7. The method as claimed in claim 6, wherein the learnt reference images are those that allow the best approximation of the representations of the particles in the training images by a linear combination of said elementary images.

8. The method as claimed in claim 1, wherein step (c) is implemented by means of a classifier, the method comprising a step (a0) of training, by data-processing means of a server, parameters of said classifier using a training database of already classified feature vectors/matrices of particles in a sample.

9. The method as claimed in claim 8, wherein said classifier is chosen from a support vector machine, a k-nearest neighbor algorithm, or a convolutional neural network.

10. The method as claimed in claim 1, wherein step (c) comprises a reduction of the number of variables of the feature vector, by means of the t-SNE algorithm.

11. The method as claimed in claim 1, for classifying a sequence of input images representing said target particle in a sample over time, wherein step (b) comprises obtaining a feature matrix of said target particle by concatenating the extracted feature vectors of each input image of said sequence.

12. A system for classifying at least one input image representing a target particle in a sample comprising at least one client comprising data-processing means, characterized in that said data-processing means are configured to implement:
extraction of a feature vector of features of said target particle, said features being numerical coefficients each associated with one elementary image of a set of elementary images each representing a reference particle such that a linear combination of said elementary images weighted by said coefficients approximates the representation of said target particle in the input image;
classification of said input image depending on said extracted feature vector.

13. The system as claimed in claim 12, further comprising a device for observing said target particle in the sample.

14. A computer program product comprising code instructions for executing a method as claimed in claim 1 for classifying at least one input image representing a target particle in a sample, when said program is executed on a computer.

15. A storage medium readable by a piece of computer equipment, on which a computer program product comprises code instructions for executing a method as claimed in claim 1 for classifying at least one input image representing a target particle in a sample.
